(19) United States
(12) Patent Application Publication
(10) Pub. No.: US 2013/0196339 A1
(43) Pub. Date: Aug. 1, 2013

(54) SLIDE POCKET

(71) Applicant: Thermo Shandon Limited, Cheshire (GB)

(72) Inventors: James L. Dowling, Milford, NH (US); Christopher J. Nolet, Francestown, NH (US); Erico von Bueren, Kalamazoo, MI (US); Eric D. Yeaton, Epsom, NH (US)

(73) Assignee: THERMO SHANDON LIMITED, Cheshire (GB)

(21) Appl. No.: 13/729,973

(22) Filed: Dec. 28, 2012

Related U.S. Application Data
(60) Provisional application No. 61/592,880, filed on Jan. 31, 2012.

(51) Int. Cl. G01N 1/31

(52) U.S. Cl. CPC G01N 1/31
USPC 435/7.1; 435/283.1

(57) ABSTRACT

A slide pocket includes a first shell portion having a slide well with a depth suitable for accepting a sample-containing portion of a slide thereby positioning a sample affixed to the sample-containing portion of the slide within the slide well. The slide well has a plurality of beveled interior walls, the beveled portions functioning to prevent the sample affixed to the sample-containing portion of the slide from contacting any surface of the slide well during insertion. The slide pocket has a second shell portion, mateable in fluid tight engagement with the first shell portion. The second shell portion has a slide well. The first and second shell portions engage to define a single continuous slide chamber, a fluid input channel and fluid input port in communication with the single continuous slide chamber, and a fluid output channel and fluid output port in communication with the single continuous slide chamber.

### BACKGROUND

1. Field of the Invention

The present invention relates generally to immuno-histochemistry (IHC) staining of tissue samples and more specifically to a slide pocket that enables randomly accessing and individually processing a single tissue slide within an automated IHC system.

2. Discussion of Background Information

Immuno-histochemistry staining (IHC staining) requires several processing sequences such as, for example, (a) deparaffinization and tissue hydration; (b) target or antigen retrieval, (c) immuno-histochemical staining, (d) counter staining and (e) tissue dehydration. Several instruments have automated the process of IHC staining. In all cases, various instrument resources (e.g., reagents, heat, pipettes, physical locations for slides, wash buffers, etc.) are required for automation. The process of automation requires either (a) the sample (tissue on a slide) to be brought to those resources or (b) resources to be brought to the sample.

All current automated IHC systems require placing samples in the area where samples are processed, i.e. where processing steps can occur. Typically, samples are first loaded in batches of slides in a rack, tray, drawer or some physical fixture that enters an area where the system applies batch processing steps. Batch processing requires treating all slides in a single batch with the same reagents in accordance with a single set of batch processing steps. This type of batch processing results in a plurality of sample slides (e.g., all those included in a single rack or tray) being immersed or contacted with one reagent volume thereby creating the possibility of cross-contamination and false signaling. Current automated IHC staining systems therefore preclude random processing of individual slides in accordance with a specific, individualized sequences of processing steps, specific processing step durations customized for each IHC slide sample, and/or application of slide-specific reagent types, temperatures, and concentrations.

A need therefore exists for a slide pocket that enables individual tissue slide processing and treatment with multiple reagents of varying concentration and temperature within an automated IHC system.

### SUMMARY OF THE INVENTION

One embodiment of the slide pocket includes a first shell portion having a slide well with a depth suitable for accepting the insertion of a sample-containing portion of a slide thereby positioning a sample affixed to the sample-containing portion of the slide within the slide well. In one embodiment, the slide well has a plurality of beveled interior walls, or wall faces, the beveled portions functioning to prevent the sample affixed to the sample-containing portion of the slide from contacting any surface of the slide well during insertion. In the present embodiment, the slide pocket has a second shell portion, mateable in fluid tight engagement with the first shell portion. The second shell portion has a slide well of depth suitable for accepting the insertion of a portion of the slide that is not a sample-containing portion of the slide.

In the present embodiment, the first and second shell portions, when in mated configuration, define a single continuous slide chamber defined by the slide wells of the first and second shell portions, a fluid input channel and fluid input port in communication with the single continuous slide chamber, and a fluid output channel and fluid output port in communication with the single continuous slide chamber.

In one embodiment, the plurality of beveled interior walls are sloped at a range of angles between 1 and 5 degrees relative to the front and back main faces of the slide. In another embodiment, the plurality of interior walls defines at least one notch.

In one embodiment, the first and second shell portions are monolithic. In another embodiment, the first and second shell portions are multi-component elements.

In one embodiment, the slide pocket has an intermediary fluid dispersal slot disposed between the input channel and the continuous slide chamber. In one embodiment, the intermediary fluid dispersal slot defines a pyramid (i.e. triangularly-shaped cavity) descending from the fluid input channel.

In one embodiment, the slide pocket is manufactured from a material capable of withstanding fluid temperatures of 0 degrees to 100 degrees C. In one embodiment, the slide pocket is injection molded. In one embodiment, the slide pocket is manufactured from a chemically inert plastic material. In one embodiment, the slide pocket is manufactured from one of Ultem®, urethane, or Vextra®. In one embodiment, the slide pocket of claim 1 wherein the slide pocket is grown from a ceramic material. In one embodiment, the slide pocket of claim 1 wherein the slide pocket is manufactured from stainless steel. In one embodiment, the slide pocket is of a hybrid construction of stainless steel and a non-metallic substance.

In one embodiment, the ratio of slide volume to volume of liquid in the slide chamber with the slide inserted is in a range of 1:0.3 to 1:10.

In one embodiment, the slide pocket has an integrally formed arm extending from an external surface for retaining and aligning the slide pocket within an automated slide processing system. In one embodiment, the slide pocket has one or more sealing gaskets disposed between the first shell portion and the second shell portion.

In one embodiment, the slide pocket has one or more slide standoffs positioned on the interior bottom surface of the continuous slide chamber for supporting an inserted slide above the interior bottom surface and enabling fluid flow around the bottom edge of the slide.

### BRIEF DESCRIPTION OF THE DRAWINGS

One will better understand these and other features, aspects, and advantages of the present invention following a review of the description, appended claims, and accompanying drawings in which:

FIG. 1 depicts a front perspective view of one embodiment of the slide pocket of the present invention.

FIG. 2 depicts a front view of the embodiment of FIG. 1.

FIG. 3 depicts a transparent view of the embodiment of FIG. 2.

FIG. 4 depicts the embodiment of FIG. 3 with a slide inserted into the slide pocket for processing.

FIG. 5 depicts a perspective cross-sectional view of an embodiment of the slide pocket of the present invention having a slide inserted therein for processing.

FIG. 6 depicts a side, exploded view of the embodiment of FIG. 4.

FIG. 7 depicts a front view of the assembled embodiment of FIG. 6 taken along cross section line A-A.

FIG. 8 depicts a front exploded view of the cross-sectioned embodiment of FIG. 7.

FIG. 9A depicts a top cross section view of the embodiment of FIG. 1.

FIG. 9B depicts a magnified portion of the embodiment of FIG. 9A.

FIG. 10 depicts an exploded perspective view of an alternate embodiment of the slide pocket.

FIG. 11 depicts an exploded front view of the embodiment of FIG. 10.

FIG. 12 depicts one embodiment of an automated IHC staining system that incorporates the slide pocket.

### DETAILED DESCRIPTION

The individual slide treatment pocket solves the problems left unaddressed by standard bulk processing IHC stainers and enables treating an individual slide with specific types and concentrations of reagents on demand and in specific volumes while eliminating the risk of cross-contamination of slide tissue samples. The slide pocket enables individual slide processing and treatment with reagents of varying concentration and temperature within an automated IHC system. The slide pocket is designed for use through the various processing steps of an IHC system such as, for example, dewaxing, alcohol dehydration, treatment with preheated antigen retrieval buffer, and rehydration with a series of alcohol (etOH), water and buffer solutions.

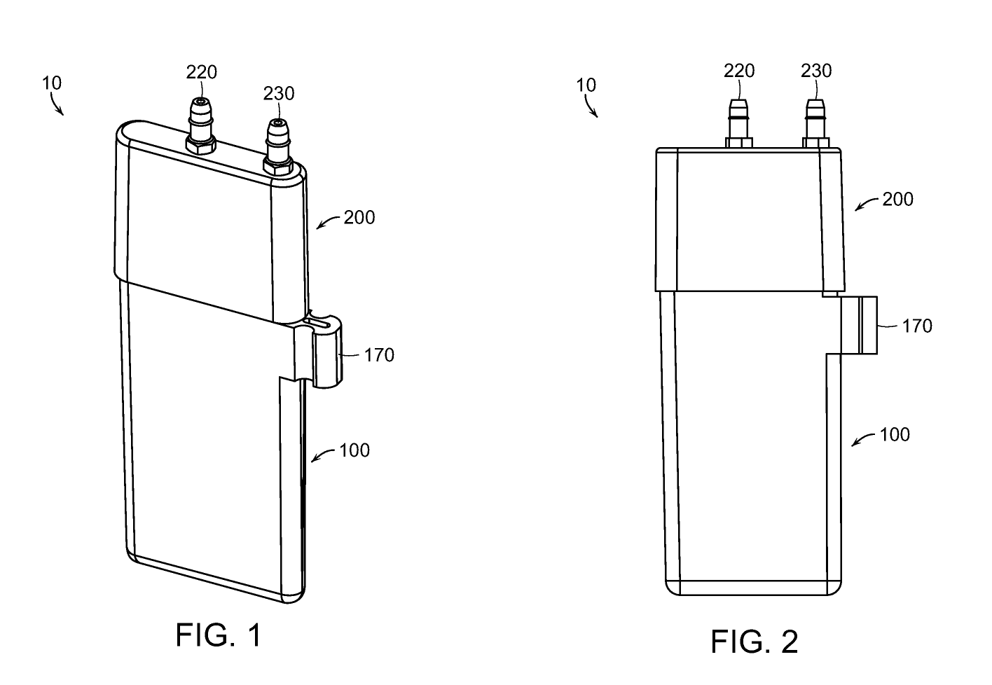

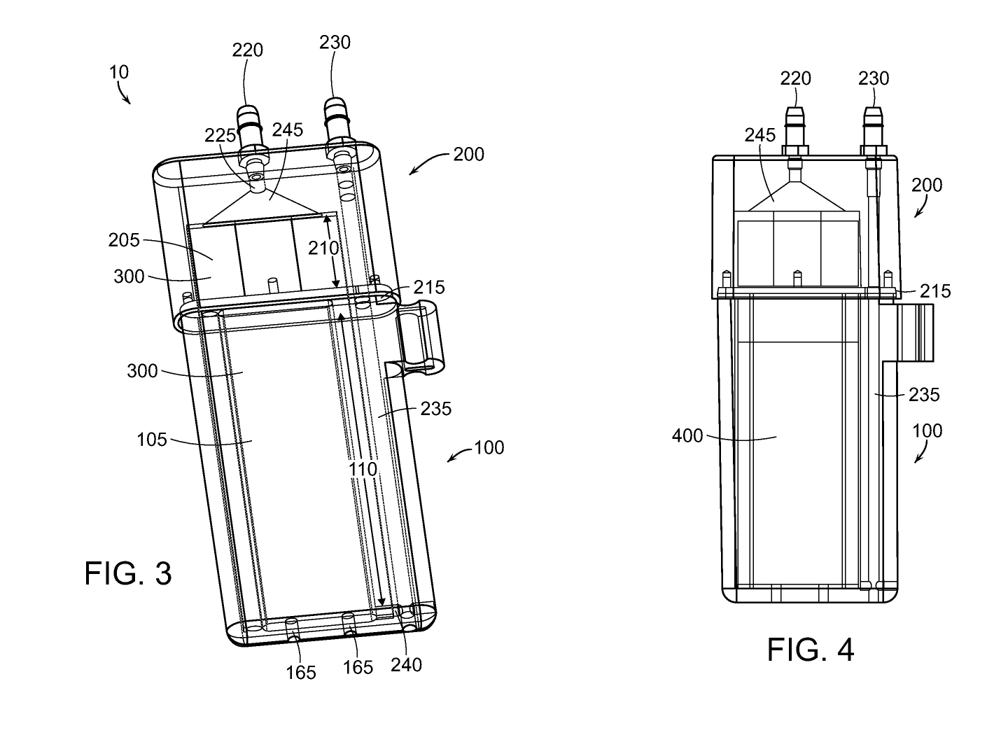

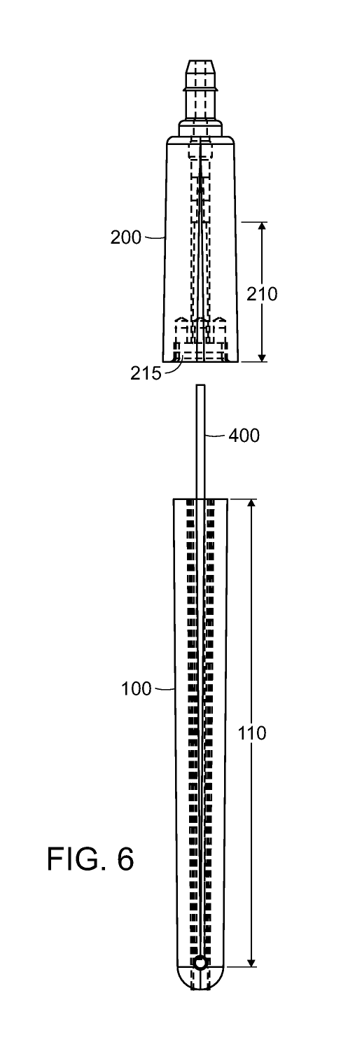

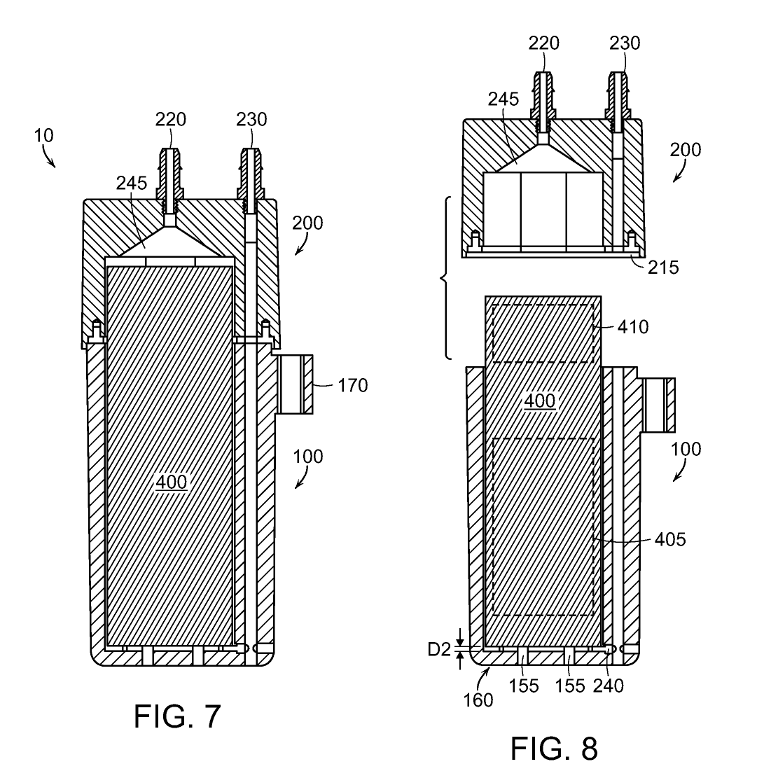

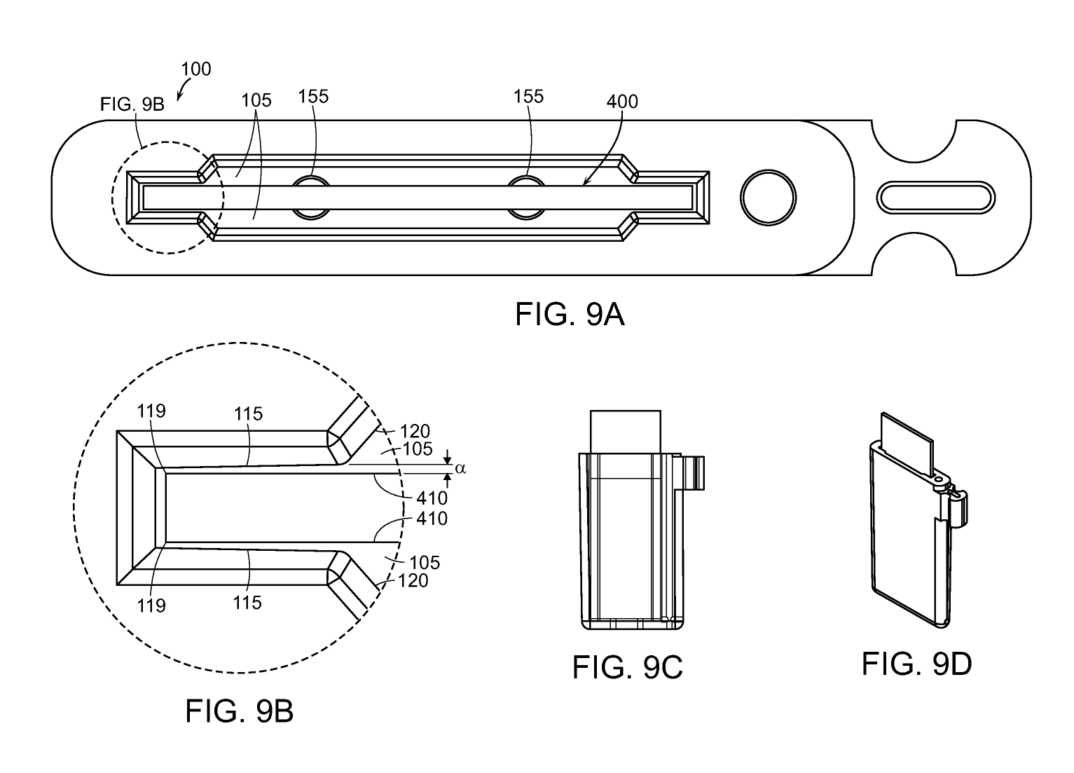

Turning now to specific slide pocket elements, FIGS. 1 through 9B depict one embodiment of the slide pocket 10. As most clearly depicted in the transparent view of FIG. 3 and/or the cross sectional view of FIG. 8, the slide pocket 10 has a first shell portion 100 and a second shell portion 200. The first shell portion 100 has a slide well 105 having a depth 110 suitable for accepting the insertion of a sample-containing portion 405 of a slide 400. As best shown in FIGS. 9A and 9B, the slide well 105 has a plurality of beveled interior walls, or wall faces 115. As used herein, the term “bevel” refers to a wall or wall face that is neither perpendicular nor parallel to a sample-containing face of a vertically-oriented slide positioned in the slide well 105. In one embodiment, the slide well 105 has a second plurality of beveled interior wall faces 120 such that the slide well 105 is double beveled. As discussed in greater detail below, the second plurality of beveled interior wall faces 120 do not contact the slide and are included only to increase the volume of the slide well 105. The first plurality of beveled interior walls, or wall faces 115, prevent a tissue sample (not shown) affixed to the sample-containing portion 405 of the slide 400 from contacting any surface of the slide well 105 during insertion, treatment and removal.

Turning back to FIGS. 1 through 3 and/or 8, the embodiment of the slide pocket 10 further includes a second shell portion 200 mateable in fluid tight engagement with the first shell portion 100. Like the first shell portion 100, the second shell portion 200 has a slide well 205 having a depth 210 suitable for accepting the insertion of a portion 410 of the slide 400 that is not a sample-containing portion 405. This portion 410 of the slide 400 may be the portion containing, for example, identifying indica relating to the sample on the slide, the patient from which the tissue sample was taken, processing steps to which the slide is to be exposed, and the like.

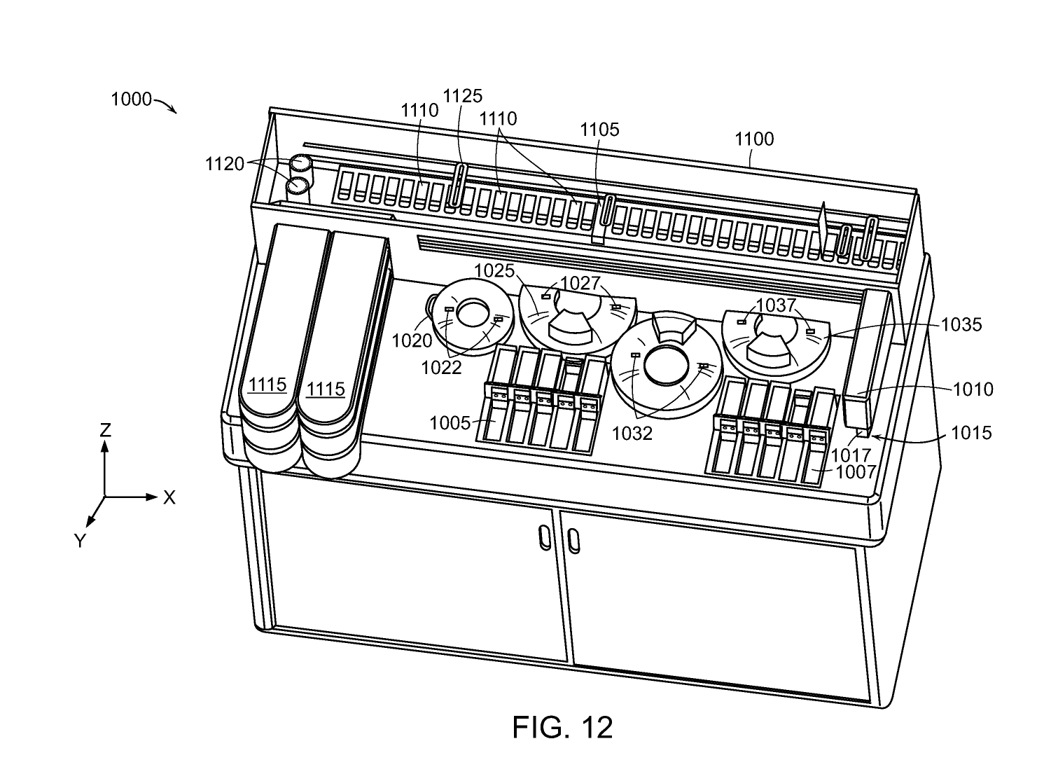

As best depicted in FIG. 3, mating the first shell portion 100 to the second shell portion 200 creates a single continuous slide chamber 300 comprised of the slide well 105 of the first slide portion 100 and the slide well 205 of the second slide portion 200. In one embodiment, one or more sealing gaskets 215 are disposed between the first shell portion 100 and second shell portion 200. In the embodiment of FIG. 8, for example, a unitary gasket 215 surrounds the opening of the slide well 215 and therefore forms a secure, fluid tight seal when engaged with the first shell portion 100. The slide pocket 10 is designed for use in an automated IHC staining system (herein after “system”) 1000. In one embodiment, shown in FIG. 12, the system 1000 includes a series of processing carousels, 1020, 1025, 1030, 1035, into which a plurality of first slide portions 100 are inserted. Incorporating slide pockets 10 in a connected pathway, such as a circle (i.e. “racetrack”), allows all slides 400 to be located at a fixed location at which design elements act to remove fluid in a slide pocket 10 and transfer a new processing fluid into that slide pocket 10 via a plurality of second shell portions 200 set at fixed positions and connected to central fluidics. All slide pockets 10 therefore individually interface with resources (e.g. remove fluid or add new fluid) at a fixed location within a carousel 1020, 1025, 1030, 1035. The slide pocket 10 may receive more than one reagent simultaneously and in a defined ration to achieve a desired concentration. This thereby eliminates the need for a separate mixing station. This also eliminates the need for a washing a mixing station to prevent crossover contamination of reagent.

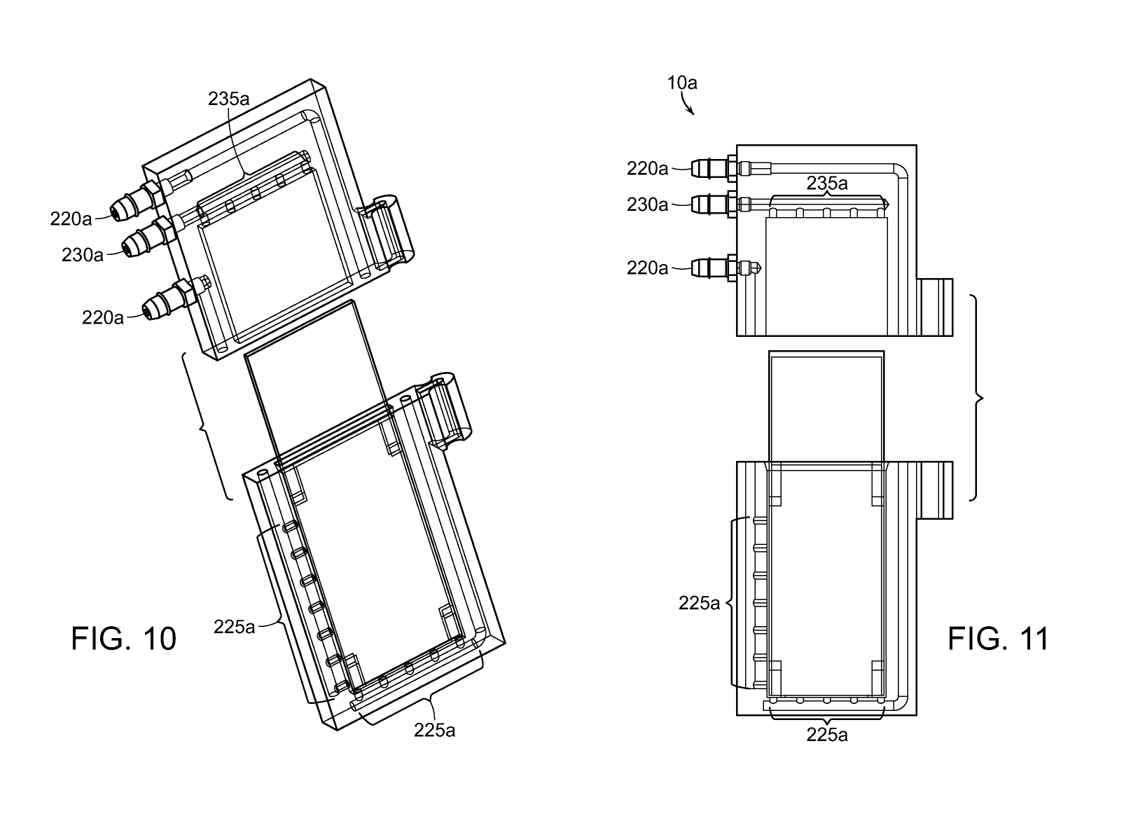

Returning to the embodiment of FIG. 3, in addition to defining a single continuous slide chamber, the engaged first shell portion 100 and second shell portion 200 comprise a fluid input port 220 and input channel 225, and a fluid output port 230 and fluid output channel 235. In one embodiment, the fluid input port 220 and fluid output port 230 are disposed in parallel though an upper surface of the second shell portion 200. One of skill in the art will recognize that the positioning of input and output porting and channeling are merely matters of design choice, and that multiple input and output ports may be provided, with associated channeling. By way of example, FIGS. 10 and 11 depict an embodiment of the slide pocket 10a having a plurality of fluid input ports 220a, plurality of fluid input channels 225a, and a plurality of fluid output channels 235a, wherein the plurality of fluid input ports 220a and the fluid output port 230a are positioned in a sidewall of the slide pocket 10a.

Turning back to the embodiment of FIGS. 3 and 8, the fluid output channel 235 is a conduit in fluid communication with the continuous slide chamber 300. In the embodiment of FIG. 3, the output channel 235 extends between an opening 240 at the bottom of the continuous slide camber 300 and the output port 230. The output channel 235 therefore is formed by mating two sections of conduit, one of each being disposed in the first shell portion 100 and the second shell portion 200, as depicted in the exploded view of FIG. 8. In alternate embodiments, the fluid output channel 235 may comprise a single conduit portion extending between the continuous slide chamber and an output port 230 disposed through a surface of the slide pocket 10 such that only the first shell portion 100 or second shell portion 200 contains the entire output channel 235. In the embodiment of FIG. 3, the output channel 235 extends throughout the length of the slide pocket 10 and is oriented parallel to the longitudinal axis of the continuous slide chamber 300. In an alternate embodiment (not shown), the longitudinal axis of the output channel 235 may be angled relative to the longitudinal axis of the slide chamber 300 such that the fluid output port 230 is spaced maximally from the fluid input port 220 on the exterior upper surface of the slide pocket 10.

Returning now to FIG. 3, one embodiment of the slide pocket 10 provides an intermediary fluid dispersal slot 245 disposed between the input port 220 and the continuous slide chamber 300. In the embodiment depicted, the fluid dispersal slot is pyramidal in shape, having an apex centered on the fluid input port 220 and the longitudinal axis of the fluid input channel 225 and descending outwardly toward the continuous slide chamber 300. The fluid dispersal slot 245 receives fluid flow from the input port 220 and input channel 225 and evenly distributes the flowing fluid across the slide 400 such that a tissue sample thereon receives a thorough and uniformly distributed application of reagent. By directing the fluid flow to provide a sheet of fluid to a slide 400, the fluid dispersal slot 245 helps to ensure that the entire sample is uniformly saturated as reagent is introduced thereby avoiding temporary “dry spots” which are only eliminated when the slide chamber 300 is full of reagent. Such dry spots can result in false negative or false positive results.

In an alternate embodiment shown in FIGS. 10 and 11, the slide pocket 10a provides thorough saturation of a tissue sample on a slide 400a by injecting fluid at several fluid input channels 225a extending into the single continuous slide chamber 300a from more than one orientation. In the embodiment of FIGS. 10 and 11, the slide pocket 10a comprises a plurality of fluid input ports 220a, at least one fluid output port 230a, a plurality of fluid input channels 225a and a plurality of fluid output channels 235a. As depicted in FIG. 10, the plurality of fluid input channels 225a are positioned in and through an interior longitudinal sidewall of the continuous slide chamber 300a and in and through a bottom wall of the continuous slide chamber 300a such that fluid simultaneously enters the continuous slide chamber 300a from the bottom and side. The fluid flow therefore impinges on a tissue containing portion 405a of the slide 400a from a plurality of flow directions and a plurality of fluid input channels 225a. This alternative embodiment ensures rapid and thorough saturation of a tissue sample disposed on a slide 400a for processing.

In all embodiments, such as that shown in FIG. 3, the slide pocket 10 has at least one fluid input channel 225 and at least one fluid output channel 235 such that fluid enters the continuous slide chamber 300 from the fluid input channel 225, saturates a tissue sample disposed on a slide 400 therein and circulates out of the continuous slide chamber 300. Although the fluid input channel 225 and fluid output channel 235 are distinctly labeled on FIG. 3, fluid may flow in either direction through the continuous slide chamber 300. In other words, fluid may flow into the continuous slide chamber 300 from the fluid output port 230 and out of the continuous slide chamber 300 through the fluid input port 220. This may be useful during processing steps and pocket rinsing steps. Regardless of flow direction, the slide pocket 10 enables continuous fluid flow therethrough such that a tissue sample placed on a slide 400 therein remains saturated. For example, during changeover of fluid from a 90 degree Celsius heated antigen removal reagent to 10 degree Celsius water, the water circulates into the continuous slide chamber 300 such that the heated antigen retrieval fluid is replaced with water while fluid coverage of the tissue sample on the slide 300 remains continuous and complete such that heat transfer occurs and prevents the evaporation of the tissue sample during removal from the slide pocket 10.

In all embodiments, the slide pocket 10 is designed for withstanding exposure to extreme temperature ranges and fluctuations and exposure to various chemistries. The slide pocket 10 is designed for washing and reuse such that cross contamination of samples is eliminated. The slide pocket 10, therefore, is manufactured from one or more inert materials capable of withstanding various chemistries and temperatures. In embodiments, the slide pocket 10 is manufactured from one or more inert materials, such as chemically inert plastic, ceramic, or stainless steel. In one embodiment, the slide pocket 10 is grown from a ceramic material. In another embodiment, the slide pocket is injection molded from a chemically inert plastic such as, but not limited to, Ultem®, urethane, or Vextra®, and the slide pocket 10 is capable of withstanding temperatures ranging from 0 degrees Celsius to 100 degrees Celsius without any degradation or catastrophic failure, even under rapid fluctuations in temperature. In another embodiment, the slide pocket 10 is manufactured from stainless steel panels having injection molded sidewalls. This hybrid material embodiment increases the rate of heat transfer during a thermal quench within the continuous slide chamber 300. In one embodiment, such as that shown in FIGS. 1 through 9, the first shell portion 100 and second shell portion 200 are each monolithic components. In another embodiment, such as that of FIGS. 10 and 11, the first shell portion 100 and second shell portion 200 are each manufactured from a plurality of components that are bonded through ultrasonic welding, adhering, reflow or some other fluid impervious bonding technique.

Returning to the embodiment depicted in FIGS. 9A and 9B, the slide pocket 10 is manufactured such that the first shell portion 100 has a plurality of beveled interior walls 115, or wall faces. In one embodiment, each beveled interior wall 115 is disposed at an angle a ranging from 1 to 5 degrees, and preferably from 1 to 2 degrees, relative to the main faces 410 of a slide 400 inserted into the slide well 105. This configuration of beveled interior walls 115 ensures that only the four longitudinal corners 119 of the slide 400 touch the interior of the slide well 105 such that the tissue sample on the tissue containing portion 405 of the slide 400 remains undisturbed.

Additionally, the plurality of beveled sidewalls 150 extend far enough such that a range of sizes of slides 400 are accommodated by the slide well 105 without touching the tissue sample on the slide 400 and while enabling effective fluid saturation and processing of the smallest slide and the largest slide. The slide pocket 10 therefore accommodates slides ranging in at least width and thickness dimensions, for example, dimensions ranging from those of the Superfrost® Plus® slides to ColorFrost® Plus® slides. In an alternate embodiment, the plurality of beveled interior walls 115 may be replaced by or supplemented with a plurality of notches (not shown) that accommodate specific ranges of slides and result in a small peripheral surface area of the main face 410 of a slide 400 touching interior surfaces of the slide well 105.

The embodiment of the slide pocket 10 of FIGS. 9A and 9B further comprises a second plurality of beveled interior walls 120 that create a “double bevel” in the interior surfaces 150 of the slide well 105, thereby rapidly increasing the volumetric space of the continuous slide chamber 300 surrounding the tissue containing portion 405 of the slide 400. This configuration further increases the clearance between the tissue sample disposed on a main face 410 of the slide 400 and an interior sidewall 150 of the slide well 105. In one embodiment, the clearance distance D1 between the main face 410 of the slide 400 and the interior sidewall 150 of the slide well 105 is between 0.01 mm and 0.10 mm, and preferably is 0.5 mm, thereby accommodating slides such as the Superfrost® Plus® slides to ColorFrost® Plus® slides. By sizing the clearance distance D1 appropriately, the continuous slide chamber 300 holds a volume of fluid sufficient for effective saturation of the tissue sample and proper fluid flow through the slide chamber. Appropriate sizing is determined by a ratio of the volume of a slide 400 to a volume of liquid in the continuous slide chamber 300 with the slide in place such that each slide is effectively and efficiently treated (e.g., thorough saturation of the tissue sample) during processing without an excessive use of reagent. These ratios preferably range from 1:0.3 to 1:10, and in one embodiment in which the slide occupies a volume of 1.344 cc and the volume of liquid in the continuous slide chamber 300 (with slide in place) is 1.848 cc, the ratio is 1:1.38. This design consideration assists with lowering the processing cost and eliminating the costs associated with filling relatively large reagent baths. As one of ordinary skill in the art will recognize, selecting larger volumes of the continuous slide chamber 300 would still enable slide processing (not unlike industry standard baths), but the larger volume would result in waste and expense associated with filling the slide chamber 300 with an excess of expensive reagent. Therefore, slide volume to slide chamber volume ratios near the 1:1 end of the scale are preferred.

The angle α is determined in part by the horizontal and rotational distances across which the smallest and largest slides will lean in the pocket. This consideration is significant in the context of an automated handling system. For example, in one automated system (not shown), a robotic arm moving about the system contains a gripper that inserts and removes a slide 400 vertically from the slide pocket 10 for delivery to various system processing areas. The gripper contact area has a tolerance within which the slide 400 must mate during retrieval. If the angle α is too large and the slide 400 is flopped forward or backward too far, the gripper will not align properly with the edges of the slide 400 for secure engagement. The angle a is toleranced such that the smallest slide 400, when tilted forward or backward to greatest extent, will still align with the contact area of the gripper such that the gripper securely engages the outer edges of the slide 400. In preferred embodiments, the gripper has a relative moh value greater than that of a glass slide 400 for secure and safe handling.

Additionally, in one embodiment (not shown), the gripper attaches to a robot arm via a series of gearing that enables the gripper to raise and lower a slide 400 vertically into and out of a slide pocket 10 and also rotate the slide 400 to a horizontal position for insertion into a horizontally oriented IHC stainer tray. In this embodiment, the robotic arm is operated by a computing system designed to schedule processing of each individual slide and therefore the movement of the robotic arm. Additionally, the robotic arm only need move in an X-Y plane because the geared gripper is designed for movement along a Z-axis as well rotational movement in a Z-Y plane about an X axis, where the X axis is parallel to the length of the automated system, the Y axis is parallel to the width of the system, and the Z-axis is parallel to the depth of the system.

Turning back to the embodiment of FIG. 3, the first shell portion 100 comprises additional features for effectively processing a slide 400 disposed within the continuous slide chamber 300. The embodiment of FIG. 3 depicts a plurality of standoffs 155 formed in or disposed through the bottom sidewall 160 of the slide pocket 10 and extending into the continuous slide chamber 300. As best depicted in the cross-sectional, exploded view of FIG. 8, the plurality of standoffs 155 contact a bottom edge of a slide 400 and hold the slide above the bottom interior surface of the slide well 105 of the first shell portion 100. For example, the plurality of standoffs 155 may hold the slide 400 at a vertical distance D2 ranging between 0.05 and 2 mm and preferably spanning a vertical distance of 1 mm. The plurality of standoffs 155 therefore enable fluid to flow continuously around the slide 400, saturating the tissue sample on the slide 400 and exiting through the opening 140 leading into the fluid output channel 235 at the bottom of the slide well 105. The gap created between the slide 400 and the bottom of the slide well 105 by the standoffs 155 enables fluid flow around the slide and effective processing of a tissue sample thereon.

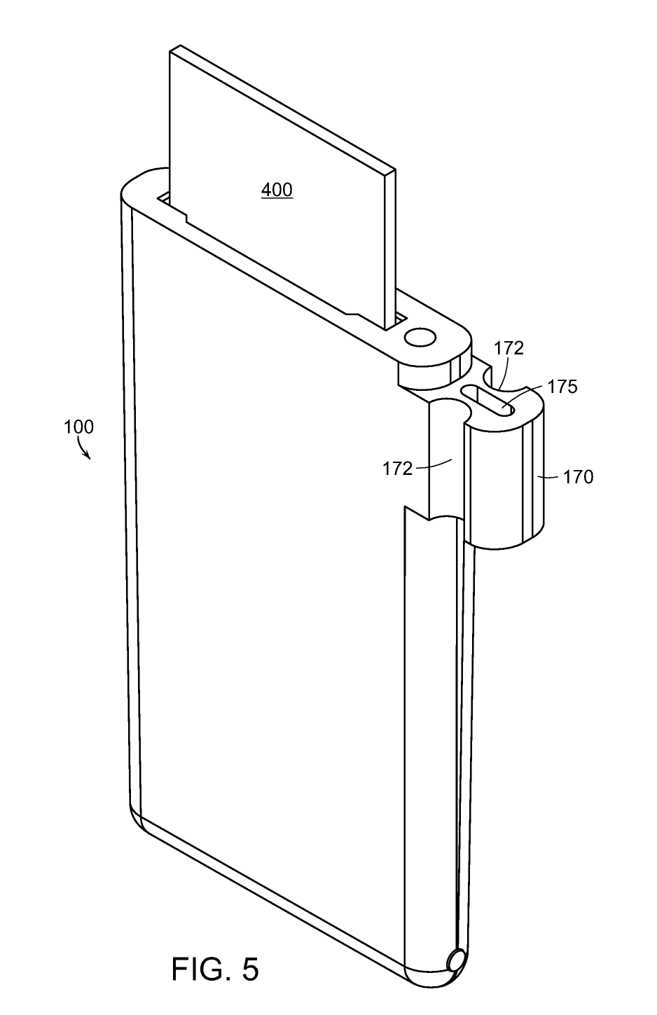

The embodiments of FIGS. 1 through 11 comprise the additional feature of a stabilization arm 170. FIG. 5 most clearly depicts the stabilization arm 170 which is a member integrally formed with the first shell portion 100 and extending laterally therefrom for engaging with a carrier (not shown) that holds the slide pocket 10 during processing. In one embodiment, the carrier comprises a pair of spaced, vertically extending dowel pins (not shown) that engage the semicircular cutouts 172 in the stabilization arm 170 for holding the slide pocket 10 upright and in toleranced alignment with portions of an automated system such as a slide gripper arm (not shown) and injection ports for feeding and removing reagents circulating through the slide pocket 10. In the embodiment of FIG. 5, the stabilization arm 170 further includes a flex slot 175 for enabling the stabilization arm 170 to fight tautly between the dowel pins of the carrier.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### EXEMPLIFICATION

The following three Examples relate to IHC staining carried out manually in Sakura baskets, and to IHC staining carried out using a slide pocket of the present invention. Example 1, for example, demonstrates surprising results in connection with a thermal quench step added following antigen retrieval pretreatment. Example 2 presents experiments suggesting that flash evaporation resulting from the brief exposure of a slide, following 98° C. treatment, to atmospheric conditions, may have resulted in peripheral tissue drying resulting in false negative results. Example 3 provides data supporting a conclusion that the use of the slide pocket tends to eliminate the type of false negative resulting from flash evaporation as reported in Example 2, when compared with otherwise identical experiments carried out in Sakura baskets. In addition to the benefits associated with a thermal quench step, the data taken as a whole demonstrate that the slide pocket is effective in eliminating temperature changes and drying caused by exposure of the sample to the environment.

### Example 1

This Example demonstrates that a cold flush step (i.e., thermal quenching) adds value to overall staining quality (after pretreatment) for antibody staining.

Design: 20 sequential tonsil sections from the same block (from a previously fixed and paraffin embedded sample) were pretreated with citrate buffer in a PT module, an automated slide dewaxing and processing device (Lab Vision Corporation, Fremont, Calif., a part of Thermo Fisher Scientific, Inc.). Five slides were processed per our current protocol (temperature ramped down to 65° C.; “° C.” refers to degrees centigrade) and served as the control; the remaining slides were processed with different post pretreatment methods in sets of 5. First set was shocked with cold buffer (3° C.) for 2 min; the second set was shocked with room temperature (RT) buffer (about 20° C.) for about 2 min; and the third set was shocked with 65° C. buffer. The samples were stained for the presence of CD68, a standard macrophage and monocyte marker. Staining was performed with anti-CD68 antibody at 1:6000 as described below. For each set of slides a control without antibody was included. The slides were processed in Sakura baskets. The procedure was as follows.

Fill PT Module with Buffer
1. Citrate buffer was supplied as 100× concentrate (Lab Vision Corporation, Fremont, Calif., a part of Thermo Fisher Scientific) Product Number TA-XXX-PM1X (where “XXX” refers to container volume) or TA-050-CBX was diluted 1 part to 99 parts distilled/de-ionized (DI) water prior to filling the tank (tank capacity is 1500 ml, so dilution is 15 ml of concentrate in 1485 ml of DI water). If citrate buffer is supplied as 10× concentrate (Lab Vision Product Number AP-9003-XXX; where “XXX” refers to container volume) it should be diluted 1 part to 9 parts DI water prior to filling tank (Tank capacity is 1500 ml, so dilution is 150 ml of concentrate in 1350 ml of DI water). The final concentration of citrate buffer was 1×. One of ordinary skill in the art would also be able to prepare citrate buffer using standard protocols.
2. PT Module tank was filled with citrate buffer, pH 6.0.

Deparaffinize Slides and Hydrate to Water
1. Slides may be heated to 60° C. just prior to use to speed removal of paraffin.
2. Paraffin was removed from sections in solvent (e.g., xylene or other deparaffinizing solvent known to those of ordinary skill in the art) using a minimum of 3 changes of 5 minutes each.
3. If the paraffin solvent is an aliphatic compound, the solution must be fresh, free of water, and the slides must be agitated or the solution stirred during the time slides are immersed.
4. The slides were then rehydrate in 3 changes of 100% ethanol, followed by 95% ethanol, 80% ethanol and 70% ethanol, for a minimum of 3 minutes in each bath.
5. The slides were placed in DI water for 5 minutes to remove remaining ethanol.

Place Slides in Pre-Heated PT Module
1. The slides were immersed in pre-heated tank containing pH 6.0 buffer. Note: Any slide rack may be used, as long as it will tolerate the temperature used.
2. The PT Module was programmed for a set temperature of 98° C., with no boil feature enabled.
3. The slides were heated in the buffer for 20 minutes.

Cool Slides in Buffer
1. The slides were cooled in citrate buffer, pH 6.0, by programming PT Module to cool to 65° C. (i.e., ramp down cooling) or cooled with 3° C. flush or RT flush. When the module reached the set cool down temperature the slides were removed from the PT Module.

Immunostain Slides
1. The treated slides were loaded onto the Autostainer™ automated slide staining instrument (Lab Vision Corporation, Fremont, Calif., a part of Thermo Fisher Scientific, Inc.) (“Autostainer” or “Automation Unit”) and the staining protocol started. Deparaffinized, hydrated slides may be stained using either chromogenic or immunohistochemical stain protocols.

An exemplary staining protocol is as follows. Many satisfactory staining protocols are known to those of ordinary skill in the art and/or are provided by the supplier of the antibody being used. An automated system, as indicated above, or manual processing may be used.

Primary Antibody Use
1. Check if primary antibody being tested is a concentrate or a RTU (Ready To Use) format.
2. If concentrate, check data sheet to determine appropriate dilution (titer) for use. If the data sheet recommends a range of dilutions, select the lowest dilution as the “recommended” dilution.
3. Incubate primary antibody as recommended in data sheet (product insert).

General, Exemplary Detection Kit Staining
1. Deparaffinize and hydrate tissue sections to water.
2. Perform antigen retrieval as described above.
3. Load slides onto Automation Unit.
4. Apply buffer wash step (tris-buffered saline (TBS) recommended).
5. Block endogenous peroxidase by incubating slides in 0.3% Hydrogen Peroxide Block for 10 minutes.
6. Apply buffer wash step (TBS recommended).
7. Apply Ultra V Block and incubate for 5 minutes at room temperature to reduce non-specific background staining.
8. Apply blow step if using Auto stainer.
9. Apply primary antibody and let remain on the specimen for the time recommended in the data sheet.
10. Apply buffer wash step (TBS recommended).
11. Apply Primary Antibody Amplifier Quanto and incubate for 10 minutes at room temperature.
12. Apply buffer wash step (TBS recommended).
13. Apply HRP Polymer Quanto and incubate for 10 minutes at room temperature. (Note: HRP Polymer Quanto is light sensitive. Please avoid unnecessary light exposure and store in opaque vial.)
14. Rinse 3 times; once with buffer, followed by DI water, and buffer respectively.
15. Prepare DAB Quanto Chromogen: Add 30 ul (1 drop) DAB Quanto Chromogen to 1 ml of DAB Quanto Substrate, mix by swirling and apply to tissue. Incubate for 5 minutes. [Warning: DAB is a listed carcinogen. Handle with care and dispose according to hazardous waste regulations.]
16. Apply DI water wash step.
17. Counterstain by using a diluted progressive hematoxylin stain (dilution only to provide weak staining).
18. Wash in running water.
19. Dehydrate slides per PWI41. Alternatively, slides may be air dried at room temperature overnight or using a 60° C. hot plate for faster drying.
20. Optionally, permanent mounting media applied with a coverslip if desired. Glass coverslips are recommended.

TABLE 1
Results: Pathologist scores and comments are as follows

| | Cold | | 65° C. | |
|---|---|---|---|---|
| Slide # | Flush 3° C. | RT Flush | Flush | Control |
| #1 | 3+ | 3+, ± | 3+, 1+ | 3+, 1+ |
| | | background | background | background |
| #2 | 3+ | 3+, ± | 3+, 1+ | 3+, 1+ |
| | | background | background | background |
| #3 | 3+ | 3+, ± | 3+, 1+ | 3+, 1+ |
| | | background | background | background |
| #4 | 3+ | 3+, ± | 3+, 1+ | 3+, 1+ |
| | | background | background | background |
| #5 | negative | negative | negative | negative |
| (diluents) | | | | |

Conclusions:
1) The cold flush appears to suppress the background staining seen with other pretreatment methods listed above.
2) The actual stain of the cold flush appears slightly lighter compared to the control even though they remain within the same scoring range (very subtle).

Summary: The results indicate that the cold flush is useful to improve staining quality in instances where an antibody gives unacceptable background staining.

### Example 2

This Example provides further data with regard to utilization of a cold flush with samples after pre-heating with regard to slides processed in Sakura baskets. The experiments are summarized below.

Purpose: To determine cold flush temperature limits

Design: Six sections each from 3 different tissues and a UTA microarray were dewaxed and rehydrated per the protocol given in Example 1. The slides were all pretreated in 98° C. buffer for 20 min followed by placing in 3° C. or 10° C. or 15° C. baths for 2 min each. Unlike the previous example, the slides were manually processed up to this point in the procedure. The slides were then stained using the Quanto detection system on the Autostainer™ as detailed in Example 1.

CD117 was identified as a candidate for this experiment because the antibody used results in high NSS. The goal of the experiment was, in part, to determine if the cold flush reduces this background. In the results below, the antibody bound to the colon core and breast cancer in a non-specific manner. Similar results were seen in the samples tested in the GIST array. MART-1 was selected for use on the UTA array because melanoma cores were present on the UTA. This combination of samples and antibodies achieved several levels of staining intensities.

TABLE 2
Results: Pathologist scores and comments are as follows

| | 3 C. | 10 C. | 15 C. |
|---|---|---|---|
| Slide # | Cold Flush | Cold Flush | Cold Flush |
| Prostate Ca, | 3+, false neg. | 3+, false neg. | 3+, false neg. |
| Androgen | ring, NSS 3 | ring, NSS 3 | ring, NSS 3 |
| Recept. | | | |
| at 1:25; | | | |
| slide #1 | | | |
| Prostate Ca, | 3+, false neg. | Very focal and | 3+, false neg. |
| AR, 1:25; | ring, NSS 3 | Mostly false | ring, NSS 3 |
| slide #2 | | neg. ring, | |
| GIST 3-core | 3− focal, ±, | 2 focal, −, ± | −, −, 2+ |
| microarray, | 3&2 focal | | focal&- |
| CD117, | | | |
| 1:50; | | | |
| slide #1 | | | |
| GIST 3-core | 3 focal, | 3+/− & 1 | 1+/2, 2 focal, |
| microarray, | 2 focal, | focal, ±, − | 2+ focal |
| CD117, 1:50; | focal 3 | | |
| slide #2 | | | |
| UTA | 4; NSS on | ± | False neg., |
| microarray, | smooth | | NSS |
| CD117, | mus. 3 | | |
| 1:50; | | | |
| Slide #1 | | | |
| UTA | 2+/4, false | − | False neg., |
| microarray, | neg/NSS | | NSS, Br |
| CD117, | | | Ca 2 |
| 1:50; | | | |
| Slide #2 | | | |
| Melanoma, | 3+/− | 3+/− | 3+ |
| Mart-1, | | | |
| 1:100; | | | |
| slide #1 | | | |
| Melanoma, | 3+ | 3+ | 3+ |
| Mart-1, | | | |
| 1:100; | | | |
| slide #2 | | | |
| UTA, | Focal 3 | Focal 2/2+ | Focal 2 |
| Mart-1, | | | |
| 1:100; | | | |
| slide #1 | | | |
| UTA, | − | − | ± |
| Mart-1, | | | |
| 1:100; | | | |
| slide #2 | | | |

Observations and Conclusions:
1) The results are very inconsistent within the same run (duplicates).
2) Overall all the slides had a central area that was stained while the peripheral tissue was unstained (thus the false negative comments from the pathologist and referred to as “False neg.” or “False neg. ring”); the staining “gradient” is pronounced in some tissues.
3) Because of the manual processing, it is possible that the slides may have dried to some extent during the transfer from the 98° C. to the various cold flush baths.
4) NSS=non-specific staining, GIST=gastrointestinal stromal tumors, UTA=universal array. UTA arrays are known to those of ordinary skill in the art.

Next Steps:
1) Determine cold flush temperature limits using CD68 on tonsil (this tissue and antibody were used in a series of experiments).
2) Confirm that slide drying was the cause of the non-homogenous staining—use pocket instead of the basket.

### Example 3

Two 2 sets of experiments were performed to determine the cut off temperature for the cold flush. One set of data were obtained using the “slide pocket” as the slide carrier, while the second set of data were obtained by using the Sakura basket as the slide carrier. The slide pocket is a self contained device designed for optimal slide processing with minimal reagent use and allowing for rapid reagent flushing and rapid sample temperature changes.

Purpose: Determine cold flush cutoff temperature

Design: #1: Ten sequential tonsil sections were placed in a slide pocket (3 batches) in the PT module when the temp reached 98° C. After 20 min in the 98° C. buffer, 2 slides each were shocked in 3° C., 10° C. and 15° C. baths. The 3° C. shock was performed for 2 min. The 10° C. and 15° C. shocks were performed for either 2 min or 5 min. Two control slides were processed in the slide pocket in the PT module for 20 min and ramped down to 65° C.

#2: Eighteen sequential tonsil sections were processed in the Sakura baskets in the PT module after the buffer reached 98° C. and were held for 20 min. Then 6 slides each were shocked in 3° C. or 10° C.; 3 each for 2 min and 5 min respectively. Six other slides were shocked at room temperature (about 17° C.) for an hour. Three slides were processed as controls per the standard procedure as described in Example 1. The control slides were ramped down to 65° C. in the PT module.

The slides from designs #1 and #2 were stained on the Autostainer with CD68 antibody at 1:6000 using the Quanto detection system (see, Example 1).

TABLE 3
Results: Pathologist scores and comments are as follows:

| | Pocket | Pocket | Basket | Basket |
|---|---|---|---|---|
| Pretreatment | Score | Comment | Score | Comment |
| Control #1 | 3+/− | — | 3+ | — |
| Control #2 | 3+/− | — | 3+ | — |
| Control #3 | X | — | 3+ | — |
| 3° C., 2 min, #1 | 3+/− | — | 3− | Focal neg. |
| 3° C., 2 min, #2 | 3+/− | — | 3− | Focal neg. |
| 3° C., 2 min, #3 | X | — | 3+/− | Focal neg. |
| 3° C., 5 min, #1 | X | — | 3+ | Focal neg. |
| 3° C., 5 min, #2 | X | — | 3 | Focal neg. |
| 3° C., 5 min, #3 | X | — | 3+ | Focal neg. |
| 10° C., 2 min, #1 | 3+/− | — | 3+/− | Focal neg. |
| 10° C., 2 min, #2 | 3+/− | — | 3+ | Focal neg. |
| 10° C., 2 min, #3 | X | — | 3+ | Focal neg. |
| 10° C., 5 min, #1 | 3+/− | — | 3+ | Focal neg. |
| 10° C., 5 min #2 | 3+/− | — | 3+ | Focal neg. |
| 10° C., 5 min, #3 | X | — | 3+ | Focal neg. |
| 15° C., 2 min, #1 | 3+/− | — | X | — |
| 15° C., 2 min #2 | 3+/− | — | X | — |
| 15° C., 2 min, #3 | X | — | X | — |
| 15° C., 5 min, #1 | 3+/− | — | X | — |
| 15° C., 5 min, #2 | 3+/− | — | X | — |
| 15° C., 5 min, #3 | X | — | X | — |
| RT, 1 hr, #1 | X | — | 3+ | Focal neg. |
| RT, 1 hr, #2 | X | — | 3+ | Focal neg. |
| RT, 1 hr, #3 | X | — | 3+ | Focal neg. |
| RT, 1 hr, #4 | X | — | 3+ | Focal neg. |
| RT, 1 hr, #5 | X | — | 3+ | Focal neg. |
| RT, 1 hr, #6 | X | — | 3+ | Focal neg. |

“X” indicates slides were not treated under the conditions listed on the table. Focal neg. indicates that the samples displayed false negative rings, as described above in Example 2. Staining was graded on a scale of 1-4 with 1 indicating little or no staining and 4 indicating the strongest staining. The designation “3+/−” is indicative of staining that is slightly less intense than the designation “3+”. The designation RT (room temperature) indicates a temperature of about 20° C.

Conclusions:
1) Overall the staining is only slightly weaker when performing immunohistochemistry (IHC) in the slide pockets than in the Sakura baskets (consistent with previous observations).
2) Regarding slides processed in the Sakura baskets, tissues dry out to some extent by transiting through the atmosphere (1-5 seconds) or are shocked further by significant changes in temperature, i.e., when moving the Sakura basket from 98° C. tank to respective shock bath.
3) The pocket seems to insulate the tissues from changes in temperature from the environment. Thus, any temperature changes are the result of processing only and not the result of environmental influence.
4) Although previous data (see, e.g., Example 1) confirm that the cold flush results in lower background staining, the cutoff temperatures cannot be well defined based on this data set.

Thus, when taken as a whole the results of these three Examples demonstrate that the slide pocket is effective in eliminating temperature changes and drying caused by exposure of the sample to the environment and the slide pockets are effective in providing for higher quality staining. For example, Example 1 shows that the use of thermal quenching is effective in decreasing background staining. Examples 2 and 3 demonstrate that the use of the slide pocket eliminates the false negative ring artifact that is observed when slides are processed in a manner that permits atmospheric exposure of the tissue sample.

We claim:

1) A slide pocket comprising:
a) a first shell portion comprising:
i) a slide well having a depth suitable for accepting the insertion of a sample-containing portion of a slide thereby positioning a sample affixed to the sample-containing portion of the slide within the slide well, the slide well having a first plurality of beveled interior walls, or wall faces, the beveled portions functioning to prevent the sample affixed to the sample-containing portion of the slide from contacting any surface of the slide well during insertion;
b) a second shell portion, mateable in fluid tight engagement with the first shell portion, the second shell portion comprising:
i) a slide well having a depth suitable for accepting the insertion of a portion of the slide of element a) that is not a sample-containing portion of the slide;
wherein the first and second shell portions, when in mated configuration, further comprise:
c) a single continuous slide chamber defined by the slide wells of the first and second shell portions;
d) a fluid input channel and fluid input port in communication with the single continuous slide chamber; and
e) a fluid output channel and fluid output port in communication with the single continuous slide chamber.

2) The slide pocket of claim 1 wherein the plurality of beveled interior walls are sloped at a range of angles between 1 and 5 degrees relative to the front and back main faces of the slide.

3) The slide pocket of claim 1 wherein the plurality of interior walls defines at least one notch.

4) The slide pocket of claim 1 wherein the first and second shell portions are monolithic.

5) The slide pocket of claim 1 wherein the first and second shell portions are multi-component elements.

6) The slide pocket of claim 1, further comprising an intermediary fluid dispersal slot disposed between the input channel.

7) The slide pocket of claim 6 wherein the intermediary fluid dispersal slot defines a pyramid descending from the fluid input channel.

8) The slide pocket of claim 1 wherein the material of manufacture withstands fluid temperatures of 0 degrees to 100 degrees C.

9) The slide pocket of claim 1 wherein the ratio of slide volume to volume of liquid in the slide chamber with the slide inserted is in a range of 1:0.3 to 1:10.

10) The slide pocket of claim 1 wherein the slide pocket is injection molded.

11) The slide pocket of claim 10 wherein the slide pocket is manufactured from a chemically inert plastic material.

12) The slide pocket of claim 11 wherein the slide pocket is manufactured from one of Ultem®, urethane, or Vextra®.

13) The slide pocket of claim 1 wherein the slide pocket is grown from a ceramic material.

14) The slide pocket of claim 1 wherein the slide pocket is manufactured from stainless steel.

15) The slide pocket of claim 1 wherein the slide pocket is of a hybrid construction of stainless steel and an non-metallic substance.

16) The slide pocket of claim 1, further comprising an arm extending from an external surface for retaining and aligning the slide pocket within an automated slide processing system.

17) The slide pocket of claim 1, further comprising one or more sealing gaskets disposed between the first shell portion and the second shell portion.

18) The slide pocket of claim 1, further comprising one or more slide standoffs positioned on the interior bottom surface of the continuous slide chamber for supporting an inserted slide above the interior bottom surface and enabling fluid flow around the bottom edge of the slide.

19) The slide pocket of claim 1, further comprising a second plurality of beveled interior wall faces arranged to provide for increased volume of the continuous slide chamber.

20) A method for conducting IHC staining, the method comprising:
a) providing a slide pocket of claim 1;
b) introducing a sample-containing slide into the slide pocket of claim 1;
c) exposing the sample on the sample-containing slide to IHC reagents for times and under conditions appropriate for IHC staining; and
d) recording IHC staining data.

21) The method of claim 20 wherein step c) includes an antigen retrieval step carried out at elevated temperature following a deparaffinization step.

22) The method of claim 21 further comprising contacting the sample with a chilled buffer immediately following the antigen retrieval step carried out at elevated temperature, and without intermediate contact between the sample and atmospheric conditions.
